(19) United States
(12) Patent Application Publication
(10) Pub. No.: US 2016/0190906 A1
(43) Pub. Date: Jun. 30, 2016

(54) Geomagnetic Device

(71) Applicant: Ballou De'Wana, Los Angeles, CA (US)

(72) Inventor: Ballou De'Wana, Los Angeles, CA (US)

(21) Appl. No.: 14/545,709

(22) Filed: Dec. 25, 2014

(51) Int. Cl. H02K 47/20

(52) U.S. Cl. CPC H02K 47/20; Y10S 74/09; H02K 53/00

(57) ABSTRACT

A portable and/or stationary device that yields enormous amount of clean energy. With a twist of the wrist the machine is capable of producing energy that will sustain the average modern household electricity needs and/or modified will be a power plant's energy source. The utility gadget is extremely cost-effective and durable as well as perdurable. A precisely leveled linear torque design maximizes energy production and efficiency of parts.

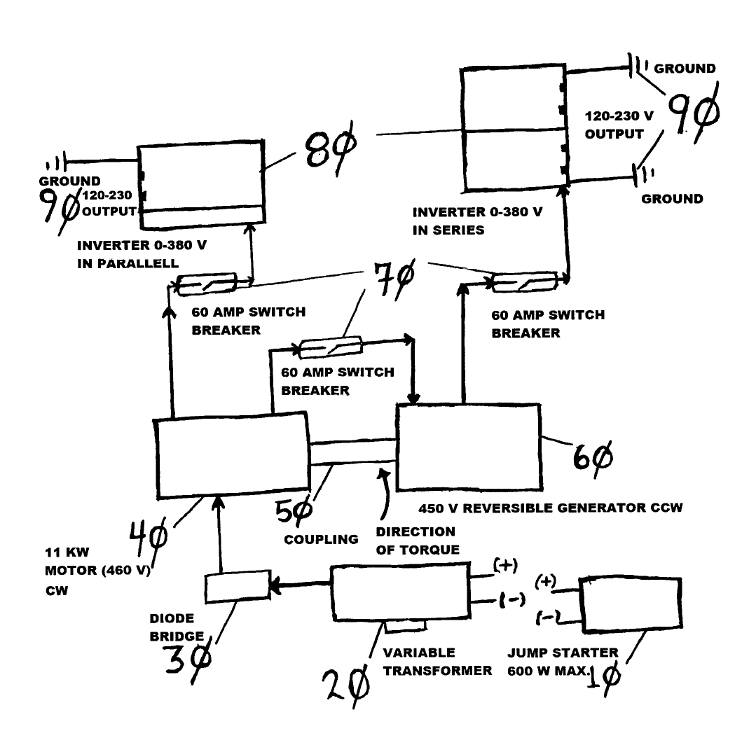

Referring now to the invention in more detail, in FIG. 1 there is shown a 600 watt max jump starter 10, variable transformer 20, diode bridge 30, 11 kilowatt motor 40, coupling 50, 450 volt reversible generator 60, 3 sixty amp switch breakers 70, a set of two 0-380 volt inverters in parallel/series 80, and two heavy grounds 90.

In more detail, still referring to the invention of FIG. 1, the geomagnetic induced current device is turned on with a mobile jump started 10. Once started the jump starter is disconnected and the variable transformer 20 is set to 50 or 60 hertz. The diode bridge 30 keeps the energy flowing into the 11 kilowatt motor 40 and not back into the variable transformer 20. The coupling 50 is manually in the reverse direction setting of the 450 volt reversible generator 60. As the energy begins to flow through the 60 amp switch breaker 70 in the on position. The voltage created is passed back to the 450 volt reversible generator 60 for continuous run; and into the 0-380 volt inverters 80 that are in parallel unless a greater kilowatt is need then it is placed in series as two separate sets to supply ac current to load which can be ie . . . appliances, deep cell batteries, capacitors, large step up and step down transformers, uninterrupted power sources, and the General Electric Power grid to name a few. The output to load from the 0-380 volt inverters 80 can be digitally calibrated to desired voltage. The grounds 90 and the breaker switches 70 are used to protect human life and wildlife.

In further detail, still referring to the invention of FIG. 1 will benefit the environment by decreasing our carbon footprint.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. The utility invention is a clean energy that will start by hand as long as there is no load or with a jump start when a load is present. Electricity created is geomagnetic current that is shared constantly from a rotating magnetic motor which is attached level accurately shaft to shaft with a dynamo. Voltage from the appliance is fed to inverters, fuse boxes, powerhouses, electrical grids, and/or used inside devices to sustain their energy needs.
